(19) United States
(12) Patent Application Publication
(10) Pub. No.: US 2010/0206142 A1
(43) Pub. Date: Aug. 19, 2010

(54) Pipe plug and cap holding tool

(76) Inventor: Laurence J. Sloane, Holliston, MA (US)

Correspondence Address: LITMAN LAW OFFICES, LTD., POST OFFICE BOX 41200, SOUTH STATION, ARLINGTON, VA, 22204, US

(21) Appl. No.: 12/656,903

(22) Filed: Feb. 18, 2010

Related U.S. Application Data
(60) Provisional application No. 61/202,339, filed on Feb. 19, 2009.

(51) Int. Cl. B25G 1/00

(52) U.S. Cl. 81/489

(57) ABSTRACT

The pipe plug and cap holding tool includes an elongate shaft having a magnetic square drive end and an opposite rotating handle. The handle end may include a square drive socket, and the medial portion of the shaft preferably includes a padded handgrip surface. The tool is used for the installation and removal of ferrous pipe fittings, i.e., caps and plugs, from relatively inaccessible installations. Cap or plug removal is accomplished by first loosening the fitting conventionally and installing a square drive socket of appropriate size or diameter on the drive end of the tool. The socket is positioned over the fitting and the tool is rotated using the medial grip portion, with the rotary handle held stationary to steady the tool. The fitting is retained in the socket due to the magnetic tip of the square drive. Installation of a fitting is accomplished by reversing the above procedure.

### CROSS-REFERENCE TO RELATED APPLICATION

This application claims the benefit of U.S. Provisional Patent Application Ser. No. 61/202,339, filed Feb. 19, 2009.

### BACKGROUND OF THE INVENTION

1. Field of the Invention

The present invention relates generally to hand tools. More specifically, the present invention relates to a pipe plug and cap holding tool having a magnetic square socket drive for driving a socket and magnetically holding a pipe plug or cap therein.

2. Description of the Related Art

The installation and use of NPT (National Pipe Thread) standard pipe and fittings has become nearly universal for threaded pipe installations for most liquid and gas line installations. While compatible tools facilitate the installation, modification, and repair of such pipe installations, the installations can be difficult to access in many instances. Examples of such occur when the pipe is buried underground or concealed within a wall, with a relatively small access drywell or panel provided for access to a pipe valve, fitting, or the like. In such instances, the worker may not be able to reach the pipe fitting (e.g., pipe plug or cap) directly with his or her free hand while manipulating a tool to remove or install the fitting. This is particularly awkward in situations where the worker must reach downwardly to access the fitting. Conventional tools do not provide a positive means of holding the fitting onto or into the end of the tool during such work, requiring the worker to resort to such temporary fixes as tape, etc. to hold the fitting onto the end of the tool for installation. Removal of the fitting from its installed location can be even more difficult, as there is no way to use such a temporary adhesive when the fitting remains installed on the pipe.

Thus, a pipe plug and cap holding tool solving the aforementioned problems is desired.

### SUMMARY OF THE INVENTION

The pipe plug and cap holding tool comprises an elongate shaft having a square drive for a socket at one end and a rotary handle or handgrip at the opposite end. The square drive includes a magnet at the distal tip thereof. The handgrip end may include a square drive socket therein. The medial portion of the shaft may include a padded handgrip surface thereon, if desired.

The tool provides for the removable installation of a socket onto the square drive end thereof, with the socket size or diameter selected according to the size and type of pipe fitting (plug or socket) to be installed. In the case of a pipe plug, the conventional square drive end of the plug is inserted in the socket to be driven by rotation of the shaft. In the case of a pipe cap, the conventional ridges extending along the opposite sides of the cap seat within opposite valleys of the internal gripping points or ridges of the socket. The attraction of the magnetic tip of the square drive attracts the ferrous metal of the pipe cap or plug to hold the cap or plug in place within the socket, regardless of the orientation of the tool. Yet, the magnetic attraction is weaker than the mechanical attachment of the socket to the extension, thereby allowing the pipe plug or cap to be released from the socket as desired without pulling the socket from the tool.

The tool is used for the installation and removal of ferrous pipe plugs and caps from relatively inaccessible locations. The removal of a pipe plug or cap is accomplished by first loosening the plug or cap using conventional tools, or driving the extension by means of a ratchet or wrench handle inserted into the square drive socket at the handle end of the extension. The tool is then rotated by hand once the plug or cap has been loosened, with rotation accomplished by rotating the medial portion of the shaft and alignment maintained by holding the rotary handgrip. Installation of a pipe plug or cap is accomplished essentially by reversing the removal procedure.

These and other features of the present invention will become readily apparent upon further review of the following specification and drawings.

### BRIEF DESCRIPTION OF THE DRAWINGS

FIG. 1 is an exploded perspective view of a pipe plug and cap holding tool according to the present invention, showing its use with different drive sockets and a pipe plug and cap.

FIG. 2 is an environmental perspective view of the pipe plug and cap holding tool according to the present invention, showing its use in installing or removing a pipe plug to a pipe.

FIG. 3 is an environmental perspective view of the pipe plug and cap holding tool according to the present invention, showing its use in installing or removing a pipe cap to a pipe.

Similar reference characters denote corresponding features consistently throughout the attached drawings.

### DETAILED DESCRIPTION OF THE PREFERRED EMBODIMENTS

The pipe plug and cap holding tool is used for temporarily holding a pipe plug or cap while removing or installing the plug or cap to the end of a perhaps difficult to access pipe. The tool is particularly useful in removing and installing plugs and caps for natural gas and other gas lines and systems, where the pipe may be concealed or difficult to reach due to a buried installation with access through a small drywell or the like.

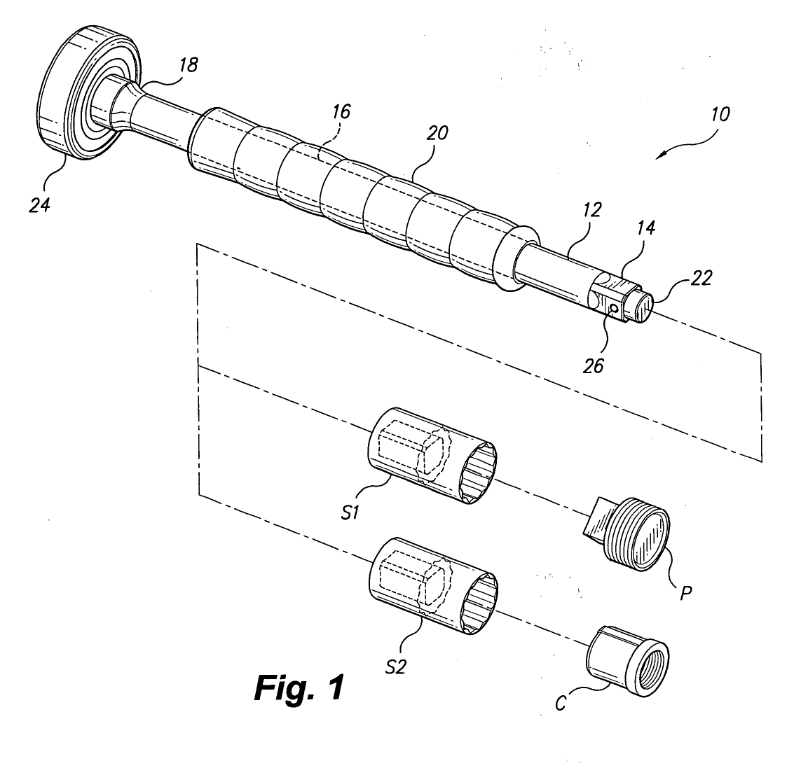

FIG. 1 provides an exploded perspective view of the tool 10 along with a pipe plug socket S1, a pipe cap socket S2, a pipe plug P, and a pipe cap C. The pipe plug and pipe cap sockets S1 and S2 are conventional sockets with square drive receptacles providing for removable attachment to a ratchet wrench or the like, with six or twelve point (facet) gripping sockets or receptacles for mating with a hexagonal nut or bolt head of corresponding span. The two pipe fittings comprising pipe plug P and pipe cap C are also conventional components. An appropriate size socket, e.g., the pipe plug socket S1, fits quite well with the square drive end of a conventional pipe plug, as does an appropriate size pipe cap socket S2 with a mating pipe cap C.

The tool 10 comprises a rigid, elongate shaft 12 having a magnetically attractive drive end 14 with a square cross section, a medial portion 16, and a handle end 18 opposite the drive end 14. The medial portion 16 of the shaft 12 is preferably provided with a resilient handgrip 20 having a high coefficient of friction, e.g., a dense neoprene or the like, to facilitate rotation of the shaft 12 by the user of the tool 10. The tool 10 may be modified from a square drive ratchet extension or the like, with the magnetically attractive drive end 14 being magnetized so that its magnetism is integral therewith, or perhaps including a separate magnet 22 permanently and immovably attached to the tip of the square drive end 14, e.g., spot welded, braised, adhesively attached, etc.

The opposite handle end 18 of the shaft 12 includes a freely turning rotary handle 24 installed concentrically thereon. The handle 24 may comprise a conventional sealed ball bearing assembly, as used in various automotive components (starters and alternators, etc.). The installation of a sealed ball bearing assembly as the rotary handle 24 provides a very smooth and low friction rotation for the outer race of the bearing or handle 24, relative to the handle end 18 of the shaft 12 upon which it is installed. The tool 10 is normally used by rotating the shaft 12 by means of the handgrip 20, while holding the outer race of the rotary handle bearing assembly 24 stationary to act as a guide for the tool.

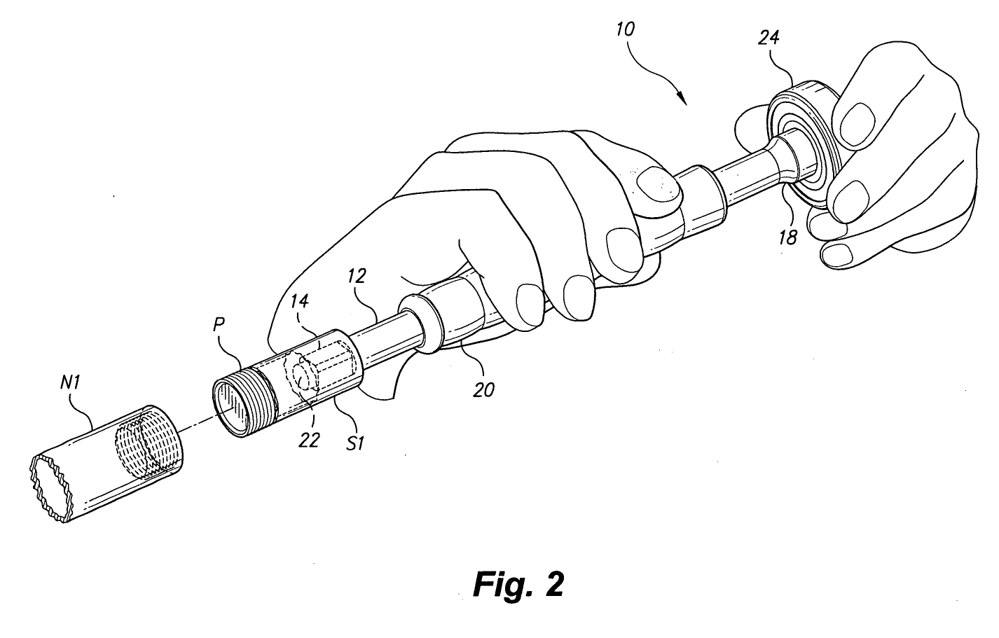

FIG. 2 provides an environmental perspective view of the use of the tool 10 in the installation or removal of a pipe plug P from a mating pipe component, e.g., an internally threaded pipe nipple N1. In FIG. 2, the pipe plug socket S1 has been removably installed upon the square drive end 14 of the tool 10, and is removably retained thereon by a conventional spring loaded, outwardly biased socket retainer or “pip pin” 26 disposed within the square drive end of the shaft and resiliently protruding therefrom, as shown in FIG. 1 of the drawings. The magnet 22 does not provide significant magnetic attraction to the ferrous metal socket S1, as the magnet 22 or magnetically attractive square drive end 14 of the tool 10 is disposed concentrically within the socket.

However, as such sockets are conventionally open from their square drive receptacles to their opposite six or twelve point fastener receptacles, the magnetic attraction produced by the magnet 22 extends through the open fastener receptacle to magnetically hold a ferrous object placed therein. Thus, the square drive end of the pipe plug P is pulled into the socket S1 by the magnetic attraction of the magnet 22 (or magnetic square drive end 14), and is prevented from turning within the socket by the points or facets within the socket gripping the corners of the square drive end of the pipe plug P.

The tool 10 is then used to remove the pipe plug P from the nipple N1 after it has been loosened, or to install the pipe plug P onto the nipple N1. Initial loosening or final tightening of the pipe plug P on the nipple N1 is accomplished by a conventional wrench or wrench and socket assembly. It will be noted that an appropriate wrench handle may be applied to the tool 10 by means of the square drive socket (not shown) conventionally provided in square drive wrench extensions, to loosen or tighten the pipe plug P.

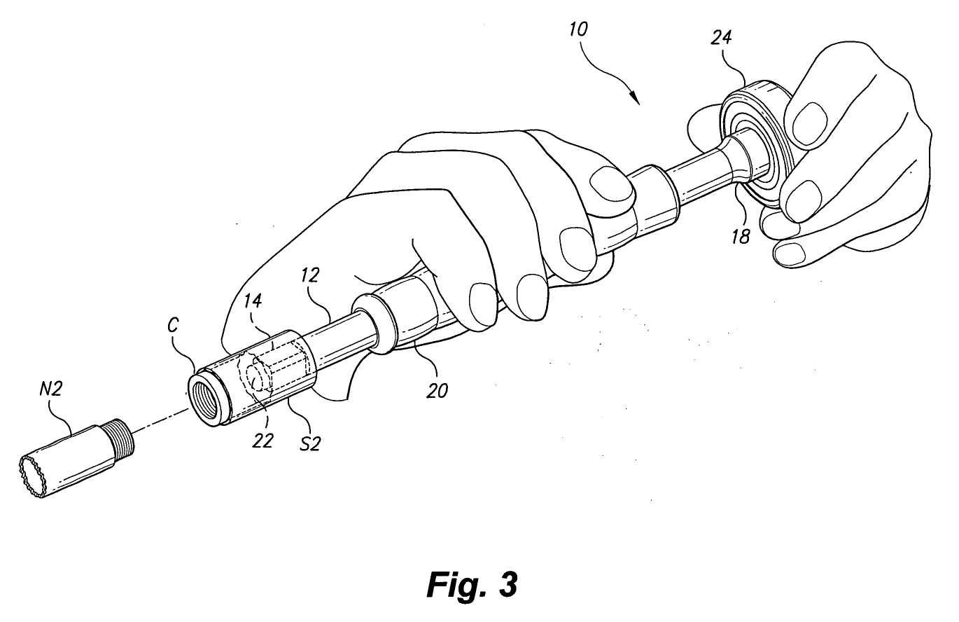

FIG. 3 is an environmental view similar to FIG. 2, but showing the use of the tool 10 in the installation or removal of a pipe cap C to or from an externally threaded pipe nipple N2. In FIG. 4, the appropriately sized socket S2 for holding a pipe cap C therein has been installed upon the square drive end 14 of the tool 10. The ferrous metal pipe cap C is magnetically retained within the drive end or fastener gripping end of the socket S2 by the magnetic attraction of the square drive end 14 of the tool 10, or magnet 22 installed thereon. The pipe cap C cannot rotate within the internal points or facets of the socket S2 due to the conventional grip ridges (one of which is shown in FIG. 1) provided on such pipe caps for gripping with a pipe wrench or the like.

The tool 10 is then used to remove the pipe cap C from the externally threaded nipple N2 after it has been loosened, or to install the pipe cap C onto the nipple N2. Initial loosening or final tightening of the pipe cap C on the nipple N2 is accomplished by a conventional wrench or wrench and socket assembly, as in the case of installation or removal of a pipe plug P as shown in FIG. 2 and described further above.

It is to be understood that the present invention is not limited to the embodiments described above, but encompasses any and all embodiments within the scope of the following claims.

I claim:

1. A pipe plug and cap holding tool, comprising:
a rigid, elongate shaft having a magnetically attractive drive end, a medial portion and a handle end opposite the drive end of the shaft, the drive end having a square cross section; and
a freely turning rotary handle disposed concentrically upon the handle end of the shaft.

2. The pipe plug and cap holding tool according to claim 1, further including a resilient, high friction grip disposed concentrically about the medial portion of the shaft.

3. The pipe plug and cap holding tool according to claim 1, further comprising:
at least one socket having a square receptacle removably mating with the drive end of the shaft; and
a pipe fitting rotationally affixed to and disposed within the socket, the pipe fitting being removably retained within the socket by the magnetically attractive drive end of the shaft when the socket is installed thereon.

4. The pipe plug and cap holding tool according to claim 3, wherein the pipe fitting is selected from the group consisting of pipe plugs and pipe caps.

5. The pipe plug and cap holding tool according to claim 1, wherein the rotary handle further includes a sealed ball bearing therein.

6. The pipe plug and cap holding tool according to claim 1, further including a spring-loaded, outwardly biased socket retainer disposed within the square drive end of the shaft and resiliently protruding therefrom.

7. The pipe plug and cap holding tool according to claim 1, wherein the magnetically attractive drive end incorporates a magnet permanently and immovably affixed thereto.

8. A pipe plug and cap holding tool, comprising:
a rigid, elongate shaft having a magnetically attractive drive end, a medial portion, and a handle end opposite the drive end of the shaft, the drive end having a square cross section; and
a resilient, high friction grip disposed concentrically about the medial portion of the shaft.

9. The pipe plug and cap holding tool according to claim 8, further including a freely turning rotary handle disposed concentrically upon the handle end of the shaft.

10. The pipe plug and cap holding tool according to claim 9, wherein the rotary handle further includes a sealed ball bearing therein.

11. The pipe plug and cap holding tool according to claim 8, further comprising:
at least one socket having a square receptacle removably mating with the drive end of the shaft; and
a pipe fitting rotationally affixed to and disposed within the socket, the pipe fitting being removably retained within the socket by the magnetically attractive drive end of the shaft when the socket is installed thereon.

12. The pipe plug and cap holding tool according to claim 11, wherein the pipe fitting is selected from the group consisting of pipe plugs and pipe caps.

13. The pipe plug and cap holding tool according to claim 8, further including a spring-loaded, outwardly biased socket retainer disposed within the square drive end of the shaft and resiliently protruding therefrom.

14. The pipe plug and cap holding tool according to claim 8, wherein the magnetically attractive drive end incorporates a magnet permanently and immovably affixed thereto.

15. A pipe plug and cap holding tool, comprising in combination:
a rigid, elongate shaft having a magnetically attractive drive end, a medial portion, and a handle end opposite the drive end of the shaft, the drive end having a square cross section;
at least one socket having a square receptacle removably mating with the drive end of the shaft; and
a pipe fitting rotationally affixed to and disposed within the socket, the pipe fitting being removably retained within the socket by the magnetically attractive drive end of the shaft when the socket is installed thereon.

16. The pipe plug and cap holding tool according to claim 15, wherein the pipe fitting is selected from the group consisting of pipe plugs and pipe caps.

17. The pipe plug and cap holding tool according to claim 15, further including a freely turning rotary handle disposed concentrically upon the handle end of the shaft.

18. The pipe plug and cap holding tool according to claim 17, wherein the rotary handle further includes a sealed ball bearing therein.

19. The pipe plug and cap holding tool according to claim 15, further including a resilient, high friction grip disposed concentrically about the medial portion of the shaft.

20. The pipe plug and cap holding tool according to claim 15, further including:
a spring-loaded, outwardly biased socket retainer disposed within the square drive end of the shaft and resiliently protruding therefrom; and
the magnetically attractive drive end incorporating a magnet permanently and immovably affixed thereto.
